(19) United States
(12) Patent Application Publication
(10) Pub. No.: US 2012/0191727 A1
(43) Pub. Date: Jul. 26, 2012

(54) SYSTEM FOR DETECTING EXTRA CRANIAL VENOUS FLOW ANOMALIES

(76) Inventor: Paolo Zamboni, Ferrara (IT)

(21) Appl. No.: 13/390,141

(22) PCT Filed: Jul. 20, 2010
(86) PCT No.: PCT/IB2010/053301

§ 371 Date: Apr. 5, 2012

(30) Foreign Application Priority Data
Aug. 11, 2009 (IT) TO2009A000633

(51) Int. Cl. G06F 17/30

(52) U.S. Cl. 707/748; 707/E17.033

(57) ABSTRACT

A system for detecting extracranial flow anomalies in a patient, for example for the purposes of the diagnosis of multiple sclerosis comprises:—a detection source (TCCS, ECD) to detect venous hemodynamics parameters representative of extracranial venous flow in a patient and generate corresponding signals, and—a processing device (PC) to receive said signals from the detection source (TCCS, ECD), configured (100, 200, 300, 400, 500), to assign to said venous hemodynami parameters respective insufficiency scores and combine (600) the respective scores assigned to said venous hemodynami parameters and generate an overall insufficiency score indicative of a level of extracranial venous flow anomaly in the patient.

### FIELD OF THE INVENTION

The present description relates to the detection of anomalies, for example due to stenosis or obstruction of the cervical and/or thoracic venous trunks, verifiable in the extracranial venous flow.

The description was devised with particular attention to possible employment in the diagnosis of multiple sclerosis.

### DESCRIPTION OF RELATED ART

It was recently reported that Multiple Sclerosis (MS) is significantly associated with a condition definable as Chronic Cerebro-Spinal Venous Insufficiency (CCSVI).

The pathogenic framework of CCSVI is characterised by multiple stenoses in the main extracranial venous draining pathways, the Internal Jugular Vein (IJV), the Vertebral Vein (VV) and the Azygous Vein (AZ), with opening of collateral vessels, a fact that is clearly demonstrable by means of selective venography. These venous stenoses cause inversion of the postural and respiratory mechanisms regulating cerebral venous reflux and can be evaluated by combined transcranial and extracranial echo Doppler techniques (Echo-Color-Doppler or ECD). In particular, the ECD technique allows measurement of venous hemodynamics parameters indicative of CCSVI.

Regarding this, the document PCT/IT2008/000129 describes a system for diagnosis of multiple sclerosis based on the determination in a patient of at least one index between the blood reflux velocity index and the increased blood resistance index in the cerebral veins, comprising a detection source set (TCCS, ECD) to detect:
i) reflux of blood in at least one of the deep cerebral veins,
ii) reflux of blood in at least one of the internal jugular and/or vertebral veins,
iii) a stenosis in at least one of the jugular veins;
iv) a lack of Doppler-detectable blood flow in at least one of the internal jugular and/or vertebral veins; and
v) a negative difference between the cross sectional area of at least one of the internal jugular veins in the supine posture and in the erect posture of the patient (for the purpose of the evaluations considered herein, the erect posture denomination also includes the seated posture, because the head is erect compared to in the supine posture).

The system also includes a processing device operatively connected to the detection source set to sense the condition in which at least two of the indexes from i) to v) are positive so that the processing device (PC) emits a warning signal when such condition is sensed. In one embodiment, the processing device is configured to assign respective risk factors to each of the above-said indexes, all of this to obtain a cumulative risk factor in function of said respective risk factor values. It is also envisioned that, for example, a respective risk value greater than any other respective risk factor be assigned to blood reflux in at least one of the internal jugular and/or vertebral veins.

### OBJECT AND SUMMARY OF THE INVENTION

The solution described in PCT/IT2008/000129 is satisfying in every way. However, the inventor has verified that there is room for further improvement of such solution, in particular concerning the evaluation of the Venous Hemodynamics (VH) parameters. The inventor has in fact observed that the assignment of risk factors, possibly differentiated from index to index, always ends up translating into empirical data with different risk factors that cannot be correlated or compared with each other in a reliable and reproducible way other than the generic acknowledgement that one particular risk factor may be “more serious” than another. The object of the invention is to provide a perfected solution capable of overcoming the intrinsic limitations connected with such mechanism of risk factor assignment.

According to the invention, such object is achieved by means of a system having the characteristics specifically recalled in the claims that follow. The claims form an integral part of the technical teaching provided herein relative to the invention.

Various embodiments envision the assignment of respective scores to the various VH parameters that, in particular when combined together (and especially because their homogeneous nature makes them combinable), allow the completely reliable automatic detection of the possible exposure to multiple sclerosis to be carried out.

Automatic assignment of scores are of increasing importance in various sectors of the art as witnessed for example, by the document EP-B-1 677 215 (Microsoft Corporation). Such document describes an automated method for the evaluation of a hypertext link included in a first webpage, with the link referring to a second webpage. The method of EP-B-1 677 215 envisions calculation of a relevance score so to define the extent to which the text representing the link of the first webpage corresponds to a title of the second webpage.

### BRIEF DESCRIPTION OF THE ANNEXED REPRESENTATIONS

The invention will now be described, by way of non-limiting example only, with reference to the annexed representations wherein:

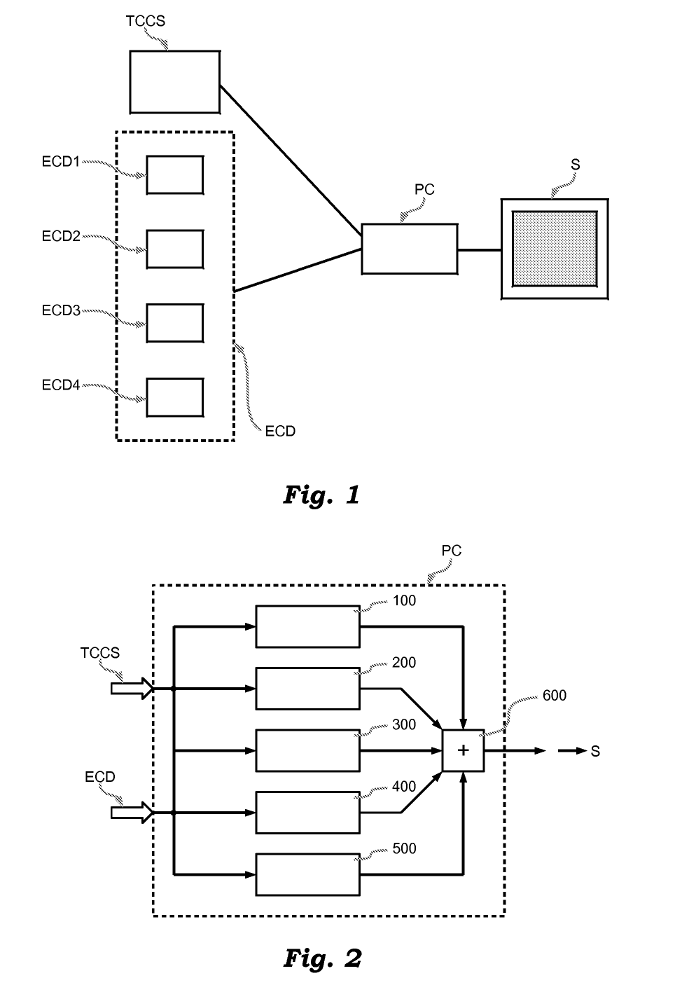

FIG. 1 is a general block diagram of a system according to one embodiment, and

FIG. 2 is an additional block diagram of a detail relative to the possible internal structure of one of the blocks in FIG. 1.

### DETAILED DESCRIPTION OF EMBODIMENTS

In the description that follows, numerous specific details will be provided to facilitate a complete understanding of the embodiments. The embodiments may be realised without one or more of the specific details, or with other methods, components, materials, etcetera. In other instances, well-known structures, materials or operations are not shown or described in detail to avoid obscuring aspects of the embodiments.

Reference throughout this description to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures or characteristic may be combined in any suitable manner in one or more embodiments.

The headings provided herein are for convenience only and do not interpret the scope or meaning of the embodiments.

FIG. 1 is a block diagram of one embodiment of a system as described herein, susceptible of determining at least one index between the blood reflux velocity index and the increased resistance index in the cerebral veins of a patient. As previously described in PCT/IT2008/000129, such indexes can be indicative of suspected exposure of a patient to Clinically Defined Multiple Sclerosis (CDMS).

The diagram in FIG. 1 (per se identical to FIG. 8 of document PCT/IT2008/000129) illustrates equipment capable of performing measurements using the techniques known as Transcranial Color-coded duplex Sonography (TCCS) and Extracranial EchoColor-Doppler (EDC).

This type of equipment is known in the art and is in routine clinical use. Examples of such equipment include ultrasound examination equipment available from ESAOTE BIOMEDICA (Italy) under the trade name MyLab™ 25 provided with 2.5 MHz (or lower) high resolution probes for TCCS or provided with the 6-13 MHz high resolution probes more suitable for the ECD technique.

Such probes are known as triplex, because they allow the examination of three levels of information:
a) highly defined morphological information with greyscale, or B-MODE;
b) pulsed Doppler hemodynamics information by direct sampling of a vessel, or PW Doppler mode. In various embodiments, the latter can be further enhanced by a so-called Multigate processor system, allowing for example discrimination of the flow directions in two deep vessels with superimposed pathways, becoming ideal for the detection, for example of a reflux in the deep cerebral veins;
c) Doppler hemodynamic information with colour coding of one or a group of vessels by sampling of an area containing it/them, or ColorMode.

In various embodiments, said TCCS and ECD equipment is connected to a processing device such as a personal computer (PC) to process the detected signals produced by the TCCS and ECD equipment that constitute a detection source of the present system.

In various embodiments, the TTCS probe constitutes a first detection source susceptible of detecting (in a way itself known, especially if enhanced by the Multigate analysis system) a reflux of blood in at least one of the deep (DCV) or middle cerebral veins. Similarly, the ECD probe constitutes a second detection source susceptible of detecting at least one from:
i) a blood reflux in at least one of the internal jugular IJV and/or vertebral veins VV;
ii) a stenosis in at least one of the internal jugular veins IJV;
iii) a lack of Doppler-detectable blood flow in at least one of the internal jugular IJV and/or vertebral VV veins; and
iv) a difference (and in particular a negative difference) between the cross sectional area (CSA) of at least one of the internal jugular veins as detected in the erect posture (for example sitting) and the supine posture of the patient.

In various embodiments, the different posture of the patient is obtainable with a tilt bed or tilt chair constituting an integral part of the equipment described. Recall that for the purpose of the evaluations considered herein, the seated posture is to be considered an erect posture because the head is erect, as opposed to in the supine posture.

Regarding this, various embodiments take into consideration the fact that the treated patients may be confined to a wheelchair, thus the sitting position or posture for these patients constitutes the most comfortable erect position to assume.

In various embodiments, the ECD apparatus or probe may include (again, in a way itself known) distinct modules from ECD1 to ECD4, each dedicated to one of the detection functions I to IV seen previously. In the exemplary embodiment to which FIG. 1 refers, the detection source set of the system thus includes two separate detection sources: the first detection source comprising the TCCS probe suitable for detecting the presence of blood reflux in at least one of the deep middle cerebral veins and the second detection probe comprising the ECD probe, suitable for detecting (at least one from) the previously indicated entities, such as i) to iv).

One skilled in the art will also appreciate that the illustrated embodiment is only one possible embodiment of the system described herein.

Embodiments of the system described herein may resort to different detection sources, for example different equipment (e.g. nuclear magnetic resonance (NMR) capable of providing the same detection information or equivalent information), or a different division of the detection actions (e.g. with a set of detection sources comprising a single integrated detection system). Furthermore, embodiments of the system described herein may provide offline detection signals, for example, with detection of the different entities involved performed separately with the acquired data stored for subsequent processing.

The detection signals/data provided by the TCCS, ECD detection sources are supplied to the processing device PC destined to process such signals and to present the results of its processing, for example visually, on an associated screen S and/or in printed form.

In various embodiments, in function of the detection data provided by the detection sources (TCCS, ECD) the processing device PC is capable of assigning a score to each of such VH parameters and obtaining, starting from such “partial” scores, an “overall” score of the Venous Hemodynamic Insufficiency Severity Score (VHISS) indicative of exposure of the patient to a pathogenic framework of Clinically Defined Multiple sclerosis (CDMS).

In various embodiments, the global VHISS is simply obtained as the sum of VHISSj partial scores with j=1, 2, . . . each referring to a corresponding VH parameter.

The diagram in FIG. 2 illustrates a possible arrangement of the processing nucleus of the processing device PC considered here as arranged in five modules indicated with 100, 200, 300, 400 and 500, respectively.

Each of such five modules is destined to evaluate, in function of the signals/data originating from the TCCS, ECD source, a respective venous hemodynamics (VH) parameter and to associate a respective insufficiency score VHISS1, VHISS2, VHISS3, VHISS4 and VHISS5 to it.

A combining module 600 then combines the VHISS1, VHISS2, VHISS3, VHISS4 and VHISS5 scores, for example summing them, so to obtain the overall insufficiency VHISS score.

It will be appreciated that the external presentation (screen S) may be selectively adjusted and thus be limited only to the global VHISS score, or present one or more of the VHISS1, VHISS2, VHISS3, VHISS4 and VHISS5 scores, for example, when this is considered preferable to the operator for the diagnostic intervention.

Each of the modules 100 to 600 can be implemented at the software level operating according to criteria themselves known based on the indications provided in the present detailed description.

The module 100 is destined to identify, starting from detection signals originating from the TCCS and/or ECD sources, the presence of reflux in the internal jugular veins (IJV) and/or in the vertebral veins (VV) evaluated both in the erect posture (for example, sitting) and in the supine posture. The possible presence of a more or less marked reflux suggests the possible presence of stenosis in the internal jugular veins IJV and/or in the azygos vein AZ.

The number of venous segments susceptible of showing reflux is substantially four segments, respectively examined in two postures.

The VHISS1 score connected to this first criterion can be attributed with a value variable from 0 (absence of conditions in which reflux has been detected) to a value equal to the number of conditions in which reflux has been detected: for example, a score equal to 8 if reflux has been observed in all four segments in both postures, thus attributing one point for each condition under which the presence of reflux has been observed in one segment.

The module 200 is destined to identify, starting from detection signals originating from the TCCS probe (for example with MultiGate processing), the presence of reflux in the deep cerebral veins (DCV) such as, for example the great cerebral vein of Galen, the internal cerebral veins, Rosenthal's vein, so to suggest the propagation of the extracranial reflux in the parenchymal veins. Such criterion can be considered positive for the purpose of detection also in the presence of reflux detected only in the veins draining the subcortical grey matter (GM) into the deep cerebral veins DCV.

In this case it is possible to determine the score operating according to the criteria outlined below.

When reflux is observed in the DCV in one posture a score equal to 1 is attributed, while in the case in which the reflux is observed in both postures a score equal to 2 is attributed. In addition, the possible detection of a reflux towards the subcortical grey matter can be weighted attributing an additional score contribution equal to 2. This is done in function of the observed correlation with greater disability.

Consequently, the VHISS2 score assigned by the module 200 may vary from 0 (absence of reflux) up to a maximum value of 4 in function of the detection of the various conditions outlined above.

The module 300 is destined to identify, for example, starting from B-mode detection signals originating from the ECD probe, the presence of stenosis in the internal jugular veins IJV in the form of annulus, webs, septa or malformed valves.

The VHISS3 score assigned by the module 300 varies from 0 to 2 depending on whether anomalies disturbing the drainage are absent (score 0), or present in one (Score 1) or both (score 2) internal jugulars IJV. The score 0 is assigned if the processing at the module 100 or the processing assigned to the module 400 (described below) correspond to the observed presence of reflux or obstructions in the internal jugular vein IJV considered in one of the postures under examination.

The module 400 is destined to identify, starting from detection signals originating from the ECD probe, the absence of Doppler signals indicative of blood flow in the internal jugular veins and/or in the vertebral veins, even after forced inspiration, both in the supine posture and in the erect posture (for example seated). The module 400 is also capable of detecting the condition in which there is absence of the Doppler signal in one posture with detection of reflux in the other posture. The blockage of drainage is correlated with a stenosis or obstruction in a distal position with respect to the evaluation point.

The VHISS4 score assigned by the module 400 ranges from 0 (absence of detected anomalous conditions) to a maximum of 8 according to the same criteria illustrated above relative to the module 100 (that is, in function of the number of conditions in which the absence of Doppler signal is detected), with the difference that only blockages are considered, in the sense that the score contribution relative to a certain segment in a certain posture is equivalent to 0 if reflux has been detected for such segment and for such posture with the assignment of a contribution score equal to 1 by the module 100.

The module 500 is destined to detect, starting from signals originating from the TCCS and/or ECD probes, the difference (ΔCSA) in Cross Sectional Area (CSA) of the internal jugular veins (IJV) obtained by subtracting the cross sectional area measured in supine position from that measured in the erect position (for example, seated).

Under normal physiological conditions, the difference ΔCSA (cross section in seated position—cross section in supine position) is positive since the internal jugular veins are the predominant draining pathway in the supine position.

Concerning the VHISS5 score values attributed by the module 500, the values may range from 0 to 2 with reference to each internal jugular vein IJV.

In particular, for each internal jugular vein IJV:
if ΔCSA is greater than or equal to a threshold value (chosen for example to be equal to 7 mm²) a score of 0 is assigned;
if ΔCSA is positive and less than the above-said threshold value, a score of 1 is assigned;
if ΔCSA is negative a score of 2 is assigned.

Thus the VHISS5 score may vary from 0 to 4.

Therefore, such assignment criterion of the VHISS5 score takes into consideration the fact that the ΔCSA, i.e. the difference between the jugular CSA measured in the supine position (head at 0° with patient lying down), which under physiological conditions is greater, and the jugular CSA measured in the seated condition (head erect at 90°), which under physiological conditions is smaller, is therefore a positive value under physiological conditions.

In many patients affected by CCSVI/MS the supine CSA shows minimal increments, or even shows values lower than the seated CSA.

This results in a positive value within the lower 25^{th} percentile (VHISS of 1), or a negative value (VHISS of 2).

The scores assigned by the single modules 100 to 500 are then combined (e.g. summed) in the module 600 so to give origin to an overall VHISS score:

VHISS=VHISS1+VHISS2+VHISS3+VHISS4+VHISS5.

In various embodiments, the VHISS value ranges from 0 to 16, given the mutually exclusive characteristics of the VHISS1, VHISS3 and VHISS4 scores.

Thus various embodiments allow identification and expression of an altered venous drainage with an indicative score of VH venous hemodynamic parameters of pathological nature such to result in an overall VHISS score that has been observed to be consistently representative of conditions observed in the patients.

Experimental tests have been performed on a panel of 16 patients affected by multiple sclerosis whose conditions were compared with those of 8 age- and sex-matched control subjects.

In each subject the VH parameters were evaluated on the same day in which each subject was subjected to a complete physical exam integrated with the attribution of an Expanded Disability Disease Score (EDSS) and a composite data of the Multiple Sclerosis Functional Composite (MSFC) type followed by an ECD evaluation.

The study of the cerebral venous reflux by ECD was performed using the Esaote MyLab™ 25 ultrasound instrument with the subject arranged on a tilt bed as described in the document PCT/IT2008/000129.

The functioning of the system described herein was tested with reference to the assignment criteria of the previously seen VHISS1 to VHISS5 scores, with calculation of the overall VHISS value as the simple arithmetic sum of the scores assigned for each criterion as described previously.

For the purpose of validating the test, the parameters were expressed as median and interquartile range (IQR). The differences between the patients affected by multiple sclerosis and the control subjects were evaluated with the Student's T Test, or where appropriate, with the Mann-Witney test. Finally, the relationship between the number of pathological VH parameters and VHISS scores observed with the system described herein and the reference parameters obtained by means of complementary instruments such as Echo-Colour Doppler (ECD) venography and Magnetic Resonance Imaging (MRI) techniques was evaluated with linear regression and linear correlation. For statistical purposes a value of p<0.05 was considered significant.

Table I reproduces the demographic and clinical data of the patients and of the control subjects (the continuous variables are expressed as mean +/− standard deviation SD).

TABLE I

| | Patients affected | Control | |
|---|---|---|---|
| Characteristic | by MS | subjects | P value |
| N | 16 | 8 | — |
| Female:Male | 10:6 (63%) | 6:2 (75%) | 0.67 |
| Age, years | 36.1 ± 7.3 | 33.1 ± 7.3 | 0.37 |
| Disease | 7.5 ± 1.9 | — | |
| duration, years | | | |
| Age at | 35.8 ± 9.2 | — | |
| diagnosis, years | | | |
| Duration of | 4.3 ± 3.4 | — | |
| treatment, years | | | |
| Mean EDSS (IQR) | 2.5 (1.4) | — | |

Table II reproduces the results of the tests obtained both in patients and in control subjects with the relative p values.

TABLE II

| | Patients affected | Control | |
|---|---|---|---|
| VH Parameter | by MS | subjects | P value |
| Total number of | 3.8 ± 0.23 | 0.12 ± 0.35 | 0.0001 |
| positive criteria | | | |
| Partial score | | | |
| distribution | | | |
| VHISS1 | 12 (75%) | 0 (0%) | |
| VHISS2 | 14 (88%) | 0 (0%) | |
| VHISS3 | 14 (88%) | 1 (13%) | |
| VHISS4 | 13 (81%) | 0 (0%) | |
| VHISS5 | 8 (50%) | 0 (0%) | |
| VHISS Score | 8.9 ± 2 | 0.3 ± 0.5 | 0.0001 |
| Mean Net CSF flow, | −13.6 ± 43 | −33.7 ± 21 | 0.038 |
| cm/s | | | |
| Mean Positive CSF | 125 ± 70 | 78.6 ± 44 | NS |
| flow, cm/s | | | |
| Mean Negative CSF | −138 ± 89 | −112 ± 41 | NS |
| flow, cm/s | | | |
| Median Total | 5.1 ± 2.4 | 3.3 ± 1.6 | NS |
| cerebral transit | | | |
| time, s. | | | |

Data in table II demonstrate that the number of VH criteria considered positive for the purpose of detection, the corresponding VHISSj scores with j=1, 2, 3, 4, 5, and therefore, the overall VHISS score are significantly higher in patients affected by multiple sclerosis MS with respect to control subjects, which confirms that the inversion of cerebral venous drainage can be correlated with the association of multiple sclerosis with a pathogenic framework of CCSVI.

The sixteen patients were selected in different geographical areas (in particular from northern Italy and from a northern state of the United States). This shows that, independent of geographic origin, cerebral venous function is scarce in subjects affected by multiple sclerosis. In particular the higher number of venous segments showing the presence of reflux, blockage of flow, B-mode extracranial venous stenosis phenomena and reduced elasticity of the internal jugular veins (IJV) show data consistent with chronic circulatory loss.

Naturally, without prejudice to the underlying principles of the invention, the details and the embodiments may vary, even appreciably, with reference to what has been described by way of example only, without departing from the scope of the invention as defined by the annexed claims.

1. A system for detecting extracranial venous flow anomalies in a patient, the system including:
a detection source to detect venous hemodynamics parameters representative of extracranial venous flow a in patient and generate corresponding signals, and
a processing device to receive said signals from said detection source, said processing device configured to assign to said venous hemodynamics parameters respective insufficiency scores and combine said respective insufficiency scores assigned to said venous hemodynamics parameters to generate an overall insufficiency score indicative of a level of extracranial venous flow anomaly in the patient.

2. The system of claim 1, wherein said processing device is configured to assign to at least two of said venous hemodynamics parameters respective insufficiency scores that are mutually correlated, whereby the insufficiency score assigned to one parameter is a function of the insufficiency score assigned to at least one other parameter.

3. The system of claim 1, wherein said detection source is configured to detect, in at least one of said erected position and supine position, reflux of blood in segments of the internal jugular veins and/or the vertebral veins, and said processing device is configured to assign a respective insufficiency score as a function of the number of conditions where reflux is detected for one of said segments.

4. The system of claim 3, wherein said processing device is configured to assign a respective insufficiency score equal to the number of conditions where reflux is detected for one of said segments.

5. The system of claim 1, wherein said detection source is configured to detect reflux in the deep cerebral veins and/or veins draining the subcortical grey matter into the deep cerebral veins and said processing device is configured to assign a respective insufficiency score:
by assigning a unitary score if reflux is detected in either of said erected position and supine position,
by assigning a double score if reflux is detected in both said erected and supine positions,
by assigning a score contribution, preferably equal to said double score, if reflux towards said subcortical grey matter is detected.

6. The system of claim 1, wherein said detection source is configured to detect stenosis in the internal jugular veins and said processing device is configured to assign a respective insufficiency score as a function of the number of jugular veins where stenosis is detected.

7. The system of claim 6, wherein said processing device is configured to assign a respective insufficiency score equal to the number of jugular veins where stenosis is detected.

8. The system of claim 6, wherein said processing device is configured to set to zero said respective insufficiency score as a function of the number of jugular veins where stenosis is detected in the presence of reflux or obstructions being detected in the respective jugular vein.

9. The system of claim 1, wherein said detection source is configured to detect, in the internal jugular veins and/or the vertebral veins, at least one condition selected out of:
the absence of a Doppler signal indicative of blood flow in both of said erected position, and supine position, or
the absence of said Doppler signal in one of said erected position and supine position and the presence of reflux in the other of said erected position and supine position,
and said processing device is configured to assign a respective insufficiency score as a function of the number of conditions where the absence of said Doppler signal is detected.

10. The system of claim 9, wherein said processing device is configured to assign a respective insufficiency score equal to the number of conditions where the absence of said Doppler signal is detected.

11. The system of claim 9, wherein said processing device is configured to assign a null score contribution to those conditions where the absence of said Doppler signal is detected and corresponding to conditions where reflux is detected.

12. The system of claim 8, wherein said processing device is configured to set to zero the respective insufficiency score assigned as a function of the number of jugular veins where stenosis is detected when said detection source detects in the respective jugular vein blood reflux or the absence of a Doppler signal indicative of blood flow in at least one of the erected position and the supine position.

13. The system of claim 1, wherein said detection source is configured to detect the cross sectional area of the internal jugular veins and said processing device is configured to assign a respective insufficiency score as a function of the variation of said cross sectional area between the erected position and the supine position.

14. The system of claim 13, wherein said processing device is configured to assign a non-null respective score if said cross sectional area decreases between the erected position and the supine position.

15. The system of claim 13, wherein said processing device is configured to:
assign a unitary score if said cross sectional area increases less than a given threshold value between the erected position and the supine position
assign a double score if said cross sectional area decreases between the erected position and the supine position.

16. The system of claim 1, wherein said processing device is configured to generate said overall insufficiency score as a sum of said respective insufficiency scores assigned to said venous hemodynamics parameters.
